(19) United States
(12) Patent Application Publication
(10) Pub. No.: US 2004/0089053 A1
(43) Pub. Date: May 13, 2004

(54) Device and method for determining a friction coefficient

(76) Inventors: Axel Kaminski, Wermelskirchen (DE); Klaus Salewski, Krefeld (DE)

Correspondence Address: Bayer Polymers, Patent Department, 100 Bayer Road, Pittsburgh, PA, 15205-9741, US

(21) Appl. No.: 10/473,331

(22) PCT Filed: Mar. 22, 2002
(86) PCT No.: PCT/EP02/03211

(30) Foreign Application Priority Data
Apr. 4, 2001 (DE) 101 16 760.1

(51) Int. Cl. G01N 19/02

(52) U.S. Cl. 73/9; 264/40.1; 425/169; 73/843; 73/847

(57) ABSTRACT

A device for determining a coefficient of friction is disclosed. The device entails means for applying a normal force to a test piece via a die, means for subjecting the test piece to a torque and means for measuring the torque transmitted to the die via the test piece. Also disclosed is a multi-steps process for determining the coefficient of friction.

The invention relates to a device and a process for determining a coefficient of friction and also to a process for releasing a moulding from an injection mould.

In the course of production of an injection-moulded moulding it is necessary to release the moulding from the injection mould. The ease of release of the moulding from the injection mould is determined by the property of the synthetic material that is being used. Automatic manufacturing of mouldings of such a type in large batch quantities presupposes that the mouldings can be released from the mould flawlessly without disruptions under the production conditions. Secure ease of release of the moulding is therefore an important criterion for the selection of, for example, a thermoplastic for manufacturing by injection moulding.

Prior to release of the moulding, said moulding adheres to the wall of the injection mould. The magnitude of this adhesion is characterised by the coefficient of static friction. In the course of release from the mould, the moulding is broken away from the wall of the injection mould. The “breakaway force” that is necessary for this is the greater, the higher the coefficient of static friction. Said coefficient accordingly represents a measure of the ease of release of the moulding from the mould: the lower the coefficient of static friction between the moulding and the wall of the mould, the more readily can the moulding be released.

Processes for determining the demouldability of mouldings consisting of thermoplastics are known from the state of the art. A conventional process is to extrude sleeves which shrink onto the core of the mould during the cooling phase and thereby generate a normal force which cannot be defined with any precision. The injection mould is opened after completion of the cooling phase, and the sleeve is stripped away from the cylindrical core of the mould, to which the sleeve adheres, by means of an annular ejector. In this connection, the forces that any required for demoulding are determined from the maximum pressures that the hydraulic system of the ejector unit exerts on the ejector. However, no single-valued coefficients of static friction can be calculated from these demoulding forces, since the normal force of the sleeve on the core of the mould is not distributed uniformly but varies locally.

An additional disadvantageous aspect of the previously known processes is the fact that the measurement of the coefficients of static friction depends to a great extent on the geometry of the moulding in question and on various other processing parameters, such as the magnitude of the holding pressure, the length of the cooling-period, the magnitude of the temperature of the wall of the mould and the speed of release of the moulding from the mould. Even in the case of plate-like injection mouldings, no uniform transmission of a normal force is obtained, by reason of sink marks in the centre of the plate. These previously known processes therefore do not enable coefficients of static friction to be measured independently of the stated boundary conditions.

The object underlying the invention, therefore, is to create an improved device and an improved process for determining a coefficient of friction and also to create an improved process for releasing mouldings from a mould.

This object is achieved by the features of the respective independent claims. Preferred embodiments are specified in the dependent claims.

The invention enables the precise ascertainment of coefficients of static friction and of sliding friction of different materials. The coefficients of static friction and of sliding friction that are ascertained represent generally valid characteristic values for the respective thermoplastic/steel pairing of the forming die. As a result, it is possible for concrete statements to be made relating to the ease of release of arbitrary injection-moulded mouldings, taking account of the normal force of a specific moulding, and also about the magnitude of the requisite “breakaway force”.

Determination of the coefficients of friction can be undertaken under the same conditions under which the release of the mouldings from the mould also takes place in production. The invention enables the coefficients of static friction and of sliding friction between the mouldings and the wall of the mould to be measured immediately prior to release of the moulding from the mould, to be specific, independently of the geometry of the moulding and subject to clearly defined injection-moulding parameters. The coefficients of friction that are ascertained therefore represent a generally valid and objective measure for assessing the ease of release of mouldings.

According to a preferred embodiment, the device that is used for implementing the measurement process consists of a drive unit and a measuring unit. In the drive unit, an electric motor that is continuously adjustable in speed acts on a toothed-belt drive via a gear mechanism.

The measuring unit is integrated into the injection mould. The sprue-side cavity of the injection mould is the so-called carrier. It can be set in rotary motion by the toothed-belt drive of the drive unit. The other half of the cavity of the injection mould is constituted by the forming die. The latter can be displaced horizontally; it is rigidly connected to a pneumatic cylinder via a normal-force transducer. Furthermore, the forming die is able to transmit rotary motions to a torque transducer. The carrier, the forming die, and the inserts for the sprue and the mould can be brought to a specified range of temperature individually and separately with water and/or oil.

In one embodiment of the process according to the invention the coefficient of static friction and/or the coefficient of sliding friction between the test piece and the forming die is/are measured. Production of the test piece is effected by the synthetic material to be investigated—for example, a plasticized thermoplastic—being injected into the mould cavity formed by the carrier and the forming die. After solidification of the synthetic material in the cavity of the mould, the measurement takes place.

The test piece may be a circular plate with a serrated edge. The diameter in this case may amount to, for example, 95 mm, and the thickness to 2.5 mm.

During the solidification of the plastic melt, the contact of the surface of the test-piece injection moulding with the forming die is maintained by the action of the pneumatic cylinder which is coupled to the forming die. The sprue of the test piece is preferably torn off by a movement of the carrier prior to the actual measurement being carried out.

The carrier is preferably rotated, together with the test piece located in it, by a defined angle of, for example, 37° by means of the toothed-belt drive of the drive unit. As a consequence of the static friction between the test piece and the die, in the process a torque is transmitted to the forming die. Said torque is registered by the torque transducer. Subsequently the injection mould is opened completely, the test piece is ejected by means of ejector pins, and then the injection mould is closed again. In the process, the carrier is rotated back into its initial position. After this, production of another test piece can take place.

Prior to the rotation of the test piece, the latter adheres to the forming die. By virtue of the rotation, this connection is released. The torque M that is necessary for this is registered by the torque transducer. From this torque, from the mean radius r of the test piece and from the normal force F acting from the forming die on the test piece, which can be adjusted on the pneumatic cylinder via the normal-force transducer, the coefficient of friction μ according to the equation

μ=M/(r*F)

is calculated. During the rotation of the test piece, the torque transmitted to the forming die changes. If the torque transducer is connected to a data logger which records the temporal progression of the change in torque graphically, a characteristic curve arises. The torque transmitted to the forming die from the test piece firstly rises steeply, attains, for example, a very pronounced maximum and then falls to a, for example, largely constant final value. The maximum torque corresponds to the coefficient of static friction; the lower, largely constant final torque corresponds to the coefficient of sliding friction.

When the maximum torque is attained, the adhesive connection between the forming die and the test piece is broken up. The same thing also occurs in the course of the release of mouldings from a mould. Accordingly, the coefficient of static friction resulting from the maximum torque represents a measure of the ease of release of mouldings from a mould.

Surprisingly, it has been shown that the coefficients of static friction and of sliding friction that are ascertained by the process according to the invention are largely independent of the respective injection-moulding conditions, in particular independent of the magnitude and duration of the holding pressure. Also surprising is the fact that the coefficients of friction are also independent of the test conditions, that is to say, of the level of the surface pressure acting on the test piece, and of the angular velocity of the rotary motion of the test piece. This means that the coefficients of static friction and of sliding friction ascertained by the process according to the invention are general characteristic values for the respective plastic material/steel pairing of the forming die.

The invention accordingly permits the actual coefficients of friction to be determined independently of the specific geometry of the mouldings and independently of the specific conditions of measurement.

The invention will be elucidated in more detail in the following on the basis of a preferred embodiment. Shown are:

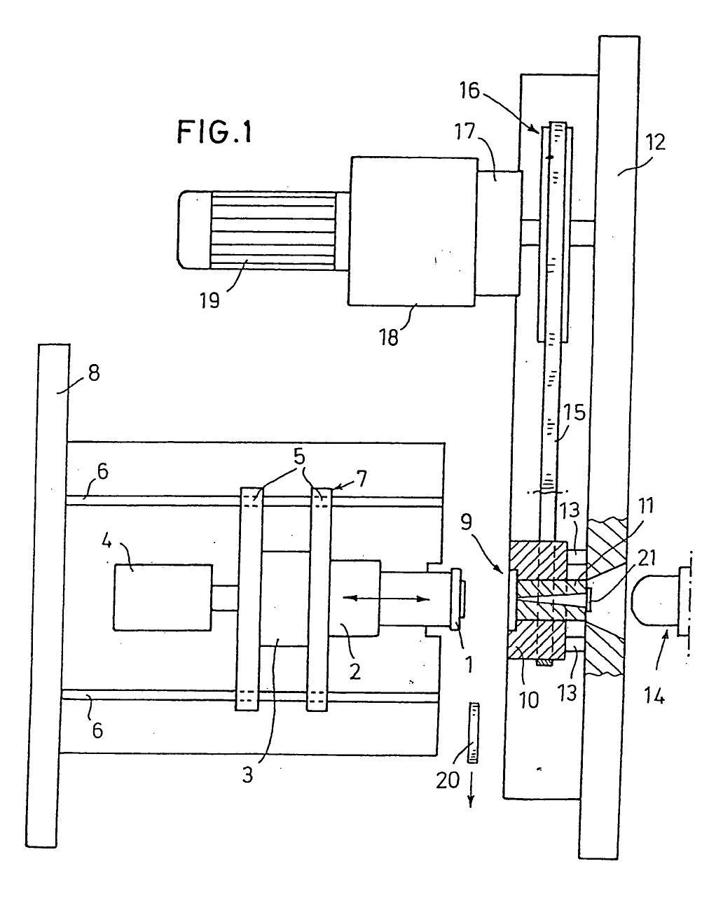

FIG. 1 an embodiment of the device according to the invention,

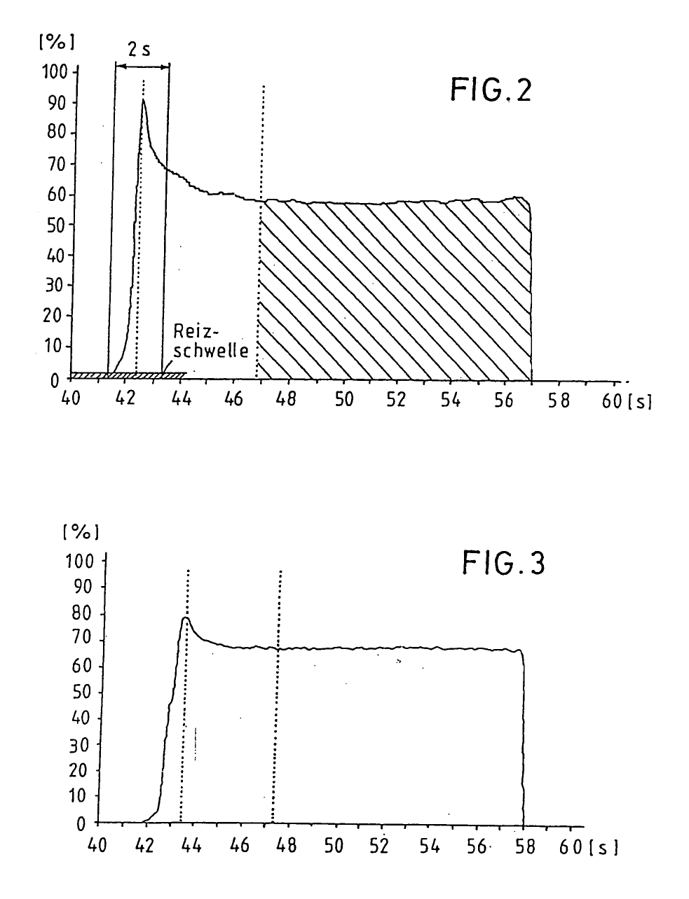

FIG. 2 a temporal torque curve measured with the device of FIG. 1,

FIG. 3 a corresponding torque curve at a particular temperature of the mould,

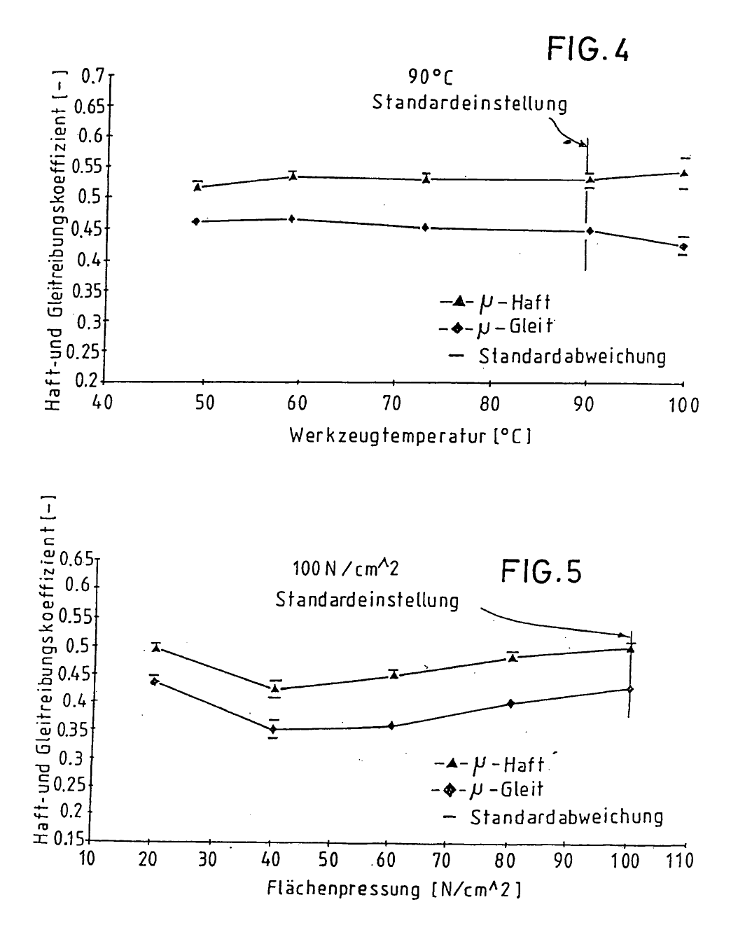

FIG. 4a curve of measured coefficients of static friction and of sliding friction as a function of the temperature of the mould,

FIG. 5 the curve of the coefficients of static friction and of sliding friction determined with the device of FIG. 1 as a function of the surface pressure, and

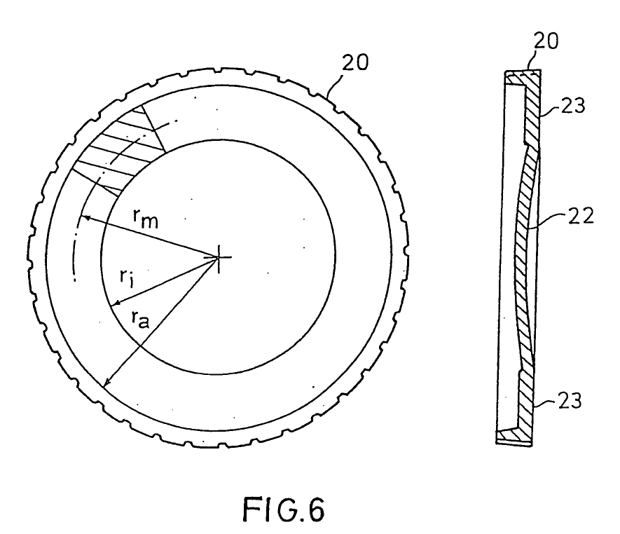

FIG. 6 a test piece that is capable of being produced with the device of FIG. 1.

FIG. 1 shows a device for determining coefficients of static friction and of sliding friction. The device includes a forming die 1 which is connected to a torque transducer 2. Arranged behind the torque transducer 2 is a normal-force transducer 3. Via a pneumatic cylinder 4 a force can be exerted on the forming die 1.

The arrangement consisting of the forming die 1, the torque transducer 2, the normal-force transducer 3 and the pneumatic cylinder 4 is held by axially supported guides 5. The corresponding guide bars 6 serve for guiding the guides 5 and also for absorbing a torque transmitted from the forming die 1 to the torque transducer 2. Total absorption of this torque by the guide bars is required when the normal-force transducer 3 is not permitted to be subjected to radial forces.

The guide bars 6 are fastened to a platen 8. Via a hydraulic system which is not represented in FIG. 1, a high pressure can be exerted on the forming die 1 for the injection moulding of plastics.

The device further includes a mould cavity 9 which, together with the forming die 1, forms a plastics injection mould. The mould cavity 9 includes a carrier 10 and a sprue bush 11. The carrier 10 and the sprue bush 11 are mobile relative to one another in the longitudinal direction; to this end, a ball bearing or slide bearing may be arranged between the carrier 10 and the sprue bush 11. Elastic elements 13, for example disc springs, are located between the carrier 10 and a platen 12.

Via a plasticating unit 14, liquid synthetic material can be introduced into the closed plastics injection mould via the sprue bush 11.

The carrier 10 is designed to accept a toothed belt 15 which is connected via a toothed-belt pulley 16 to an electric motor 19 via a clutch 17 and a gear mechanism 18.

The implementation of a measurement of a coefficient of static friction and/or of sliding friction is carried out in the following way. Firstly the injection mould is closed, i.e. the forming die 1 is moved into its mould cavity 9. In the process the elastic elements 13 between the carrier 10 and the platen 12 are compressed. Via the sprue bush 11, liquid synthetic material is injected into the injection mould from the plasticating unit 14, whereby—as is generally conventional in the case of plastics injection machines—high pressures act via the hydraulic system which is not shown in FIG. 1.

As a result of the injection of the liquid synthetic material into the injection mould, a test piece is formed therein from the plastic material to be investigated. The actual determination of the coefficients of static friction and/or of sliding friction can be carried out after a requisite cooling period has elapsed, i.e. after solidification of the synthetic material in the injection mould.

To this end, firstly the forming die 1 is moved back a short distance, for example 2 mm. This movement of the forming die 1 is tracked by the carrier 10 by reason of the force of the elastic elements 13 which acts in the direction of motion of the forming die. In the course of this movement of the plastics injection mould, the positive closure between the forming die 1 and the mould cavity 9 is maintained at any given time, so that the contact between the test piece 20 and the forming die 1 persists.

In the course of the movement of the carrier 10 in the longitudinal direction, the sprue bush 11 remains stationary, so that the sprue 21, which has arisen in the course of the plastics injection-moulding operation, tears off from the test piece 20 located in the injection mould. Separating the sprue 21 from the test piece 20 prior to implementation of the measurements is advantageous in order to avoid a falsification of the result of measurement by virtue of the sprue 21.

With a view to implementing the measurement of the coefficients of static friction and/or of sliding friction of the test piece 20 in the plastics injection mould, firstly a normal force is applied to the forming die 1, in order to press the forming die 1 against the test piece 20. The normal force that is applied from the pneumatic cylinder 4 may lie within a range between 300 N and 3000 N, preferably 1500 N to 3000 N. After the normal force has been applied, the electric motor 19 is switched on, in order to transit a torque to the test piece 20 via the gear mechanism 18, the clutch 17, the toothed-belt pulley 16 and the toothed belt 15 via the carrier 10. With a view to reliable transmission of this torque to the test piece 20, the latter is preferably located in positive closure with the part of the cavity of the injection mould that is formed by the carrier 10. The gear mechanism 18 preferably has a gear ratio of 1 to 200, in order to provide the requisite torque.

By virtue of the torque, the test piece 20 undergoes a defined rotary motion by, for example, 37° about the central axis. In the course of this rotary motion, the torque acting on the test piece 20 is transmitted entirely or partially to the forming die 1. The torque transmitted is measured and registered by the torque transducer. To this end, the torque transducer 2 may be connected to a so-called data logger, in order to acquire the temporal progression of the torque transmitted to the forming die 1 from the test piece 20. In the course of the rotation of the test piece 20, a transition takes place from static friction to sliding friction, this being reflected in a characteristic temporal torque progression which is measured by the torque transducer 2.

FIG. 2 shows a characteristic torque curve which is ascertained by the torque transducer 2 in the course of implementation of a measurement on the test piece 20 (cf. FIG. 1). The measured curve of FIG. 2 shows the progression of the torque measured by the torque transducer 2 as a percentage of the maximum torque over the time-axis. After the so-called stimulation threshold has been attained, the torque curve firstly rises steeply, as the forming die 1 and the test piece 20 are, to begin with, still located in the range of static friction. The torque curve attains a pronounced maximum—in the example shown, at approximately 90% scale divisions approximately one second after the stimulation threshold has been exceeded. The maximum torque ascertained in this way, and also the normal force applied to the forming die 1 via the pneumatic cylinder 4, and the mean radius r of the test piece 20 enter into the calculation of the coefficient of static friction.

After the maximum torque has been attained, the torque curve declines and then reaches the range of sliding friction which is shown by the cross-hatched area. Within the range of sliding friction the torque transmitted amounts to approximately 60%. Correspondingly, the coefficient of sliding friction is determined from the torque transmitted in the case of sliding friction and also from the normal force and from the mean radius r of the test piece 20. After the measurement has been carried out, the injection mould is opened, i.e. the forming die 1 is moved back and the test piece 20 is ejected from the mould cavity 9—as shown in FIG. 1. After this, the plastics injection mould is closed again, in order to produce a further test piece 20 for the implementation of a further measurement. In advantageous manner, the same measurement is undertaken approximately five to ten times in succession under the same boundary conditions and with the plastic material. The coefficients of static friction and of sliding friction that are determined in the given case are then averaged, in order to increase the precision of the result of measurement still further. This can be done automatically by an appropriate evaluation program in the data logger.

FIG. 3 shows a measured example corresponding to the diagram of FIG. 2, which in respect of a test piece consisting of polycarbonate (Makrolon 2800) has been injection-moulded in a device according to FIG. 1 under the following conditions:

melt temperature: 300° C.

mould temperature: 90° C.

injection speed: 40 mm/sec

holding pressure: 600 bar

The injection-moulded test piece is a 2.5 mm thick, centrally gated circular plate with a serrated edge having a diameter of 95 mm.

The time of completion of the holding-pressure phase is determined by measurement of the internal pressure of the mould by means of a pressure sensor in the injection mould. After completion of the holding-pressure phase, the forming die 1 was pressed against the test piece 20 by means of the pneumatic cylinder 4 (cf. FIG. 1) with a normal force of 3200 newtons. The normal force was adjusted with the aid of the normal-force transducer with a range of measurement from 0 to 10 kilonewtons.

After completion of the plastication phase, the nozzle of the plasticating unit 14 was removed from the mould. Subsequently the injection mould was opened by 5 mm, whereby the sprue 21 was torn off by the carrier 10 which has been pressed out of its seat. After this, the carrier and the test piece 20 located in it were rotated by an angle of 37° with the aid of the drive unit of the electric motor 19 at a speed of 0.5 mm/sec (relative to the mean radius of the test piece).

The torques transmitted to the forming die 1 in the process were measured and registered by the torque transducer 2 which is integrated into the measuring device (range of measurement: 0 newton.metres to 200 newton.metres) with the aid of strain gauges in accordance with the principle of resistance measurement. The data obtained in this way were transmitted to the data logger, which recorded the temporal progression of the torques of FIG. 3. A coefficient of static friction of 0.515 results from the maximum of the torque curve, and a coefficient of sliding friction of 0.439 results from the temporally constant final values of the torque in the sliding-friction range.

FIG. 4 shows the coefficients of static friction and of sliding friction that can be ascertained with the aid of the measuring arrangement of FIG. 1 as a function of the temperature of the plastics injection mould. The upper curve of FIG. 4 specifies the measured coefficients of static friction, and the lower curve specifies the measured coefficients of sliding friction. The temperature of the mould was varied within a wide range between 50° C. and 100° C. From the progression of the curve of FIG. 4 it is evident that both the coefficient of static friction and the coefficient of sliding friction are capable of being determined largely independently of the temperature of the mould in the device of FIG. 1.

FIG. 5 shows the results of measurements carried out with the device of FIG. 1 at varying surface pressures. The upper curve in FIG. 5 again specifies the ascertained coefficients of static friction; the lower curve specifies the coefficients of sliding friction. To this end, varying normal pressures were applied to the test piece 20 via the pneumatic cylinder 4, so that the varying surface pressures arise.

From the curves of FIG. 5 it is evident that the ascertainment of the coefficients of friction in the device of FIG. 1 is only influenced to a small degree by the magnitude of the surface pressure.

FIG. 6 shows an enlarged view of the test piece 20, in a top view and in a lateral section. The test piece 20 has a serrated contour on its outer periphery, in order to guarantee a reliable positive closure with the carrier 10 with a view to transmitting the torque. In its central region the test piece 20 has a curvature 22. The curvature 22 serves for increasing the elasticity of the test piece, in order to prevent deformations in the case of a shrinkage process in the course of cooling of the test piece. By this means, it is guaranteed that the test piece 20, in the planar regions 23 thereof, bears against the surface of the forming die 1 in planar manner. The region 23 has an internal radius rᵢ and an external radius rₐ, from which a mean radius rₘ results which is used for the calculation of the coefficients of friction. For example, the test piece 20 may exhibit a diameter of 95 mm, an internal radius rᵢ of 28 mm and an external radius rₐ of 42 mm.

The invention accordingly permits an exact and generally valid determination of the coefficients of static friction and of sliding friction with a view to precise ascertainment of the requisite “breakaway force” of an arbitrary moulding from the injection mould. This constitutes a quite substantial advance in comparison with the sleeve demoulding process known from the state of the art, which does not provide generally valid demoulding forces but only provides the demoulding forces that are specific to the moulding and to the process.

List of Reference Symbols

1. Forming die

2. Torque transducer

3. Normal-force transducer

4. Pneumatic cylinder

5. Guides

6. Guide bar

7. Guide plate

8. Platen

9. Mould cavity

10. Carrier

11. Sprue bush

12. Platen

13. Elastic element

14. Plasticating unit

15. Toothed belt

16. Toothed-belt pulley

17. Clutch

18. Gear mechanism

19. Electric motor

20. Test piece

21. Sprue

22. Curvature

23. Planar region

1. A device for determining a coefficient of friction with means (4) for applying a normal force to a test piece (20) via a die (1), means for subjecting the test piece to a torque and means (2) for measuring the torque transmitted to the die via the test piece.

2. Device according to claim 1, wherein the die takes the form of a forming die of an injection mould for accommodating the test piece.

3. Device according to claim 1 or 2, wherein the normal force is transmitted to the die from a pneumatic system.

4. Device according to claim 1, 2 or 3, with means (3) for measuring the normal force.

5. Device according to one of the preceding claims, with a data-acquisition instrument for acquiring measured torque data provided by the measurement means.

6. Device according to one of the preceding claims, with an injection mould including a forming die and a mould cavity for the purpose of forming the test piece.

7. Device according to claim 6, wherein the mould cavity comprises a sprue bush and a carrier, and the sprue bush and the carrier are mobile relative to one another.

8. Device according to claim 7, with elastic means (13), in particular disc springs, for applying a force to the carrier for the purpose of moving the carrier relative to the sprue bush.

9. Device according to one of claims 7 or 8, wherein the carrier is designed for positive accommodation of the test piece.

10. Device according to claim 9, wherein the carrier exhibits a rough or serrated region in a region of the cavity of the injection mould for the purpose of establishing the positive closure with the test piece.

11. Device according to one of claims 6 to 10, wherein the injection mould is designed in such a way that the test piece which is capable of being produced in the injection mould is curved in an inner region and is plane in an outer region.

12. Device according to one of the preceding claims, wherein the means for subjecting the test piece to a torque exhibit a V-belt drive or toothed-belt drive.

13. A process for determining a coefficient of friction, having the following steps:
producing a test piece in an injection mould,
applying a normal force to the test piece via a forming die of the injection mould,
subjecting the test piece to a torque,
measuring the torque transmitted to the forming die via the test piece and
determining the coefficient of friction from the normal force and the transmitted torque.

14. Process according to claim 13, wherein the test piece is produced with a plane surface in a first region and with a curvature in a second region.

15. Process according to claim 13 or 14, wherein the normal force is generated pneumatically.

16. Process according to claim 13, 14 or 15, wherein the normal force is predetermined and the transmitted torque is registered with a data-acquisition instrument.

17. Process according to one of claims 13 to 16, wherein the period of acquisition of the transmitted torque extends to the period of the transition from static friction to sliding friction between the forming die and the test piece.

18. Process according to one of claims 13 to 17, wherein the test piece exhibits a serrated or rough contour in a marginal region for the purpose of creating a positive closure with a mould cavity of the injection mould.

19. Process according to one of claims 13 to 18, wherein the torque in the injection-moulding process is transmitted via the contact between the test-piece injection moulding and the forming die.

20. Process according to one of claims 13 to 19, wherein a sprue of the test piece is removed prior to subjecting the test piece to a torque.

21. Process according to claim 20, wherein removal of the sprue is effected by a relative motion of a carrier, via which the torque is capable of being introduced into the test piece, and of a sprue bush of the injection mould.

22. A process for releasing an arbitrary moulding from an injection mould with a force, wherein the magnitude of the force that is necessary for the release of the moulding from the mould is based on the ascertainment of a coefficient of friction by a process according to one of claims 13 to 21.
